(19) United States
(12) Patent Application Publication
(10) Pub. No.: US 2005/0073710 A1
(43) Pub. Date: Apr. 7, 2005

(54) Method and system for suppressing printing of graphics in a POS printer

(76) Inventors: Terrence J. Campbell, Ithaca, NY (US); Ralph W. Hill, Ithaca, NY (US); Andrew Kobziar, Ithaca, NY (US); John E. Tarbotton, Ithaca, NY (US)

Correspondence Address: BOND, SCHOENECK & KING, PLLC, ONE LINCOLN CENTER, SYRACUSE, NY, 13202-1355, US

(21) Appl. No.: 10/784,023

(22) Filed: Feb. 20, 2004

Related U.S. Application Data
(60) Provisional application No. 60/448,621, filed on Feb. 20, 2003.

(51) Int. Cl. G06F 15/00

(52) U.S. Cl. 358/1.14

(57) ABSTRACT

A method of controlling the printing of graphic enhancements to a POS receipt using additional configuration commands. The method is implemented in a POS printer by designating exception byte strings (i.e., not usual text in receipts) to act as triggers for the suspension of the normal launching of a selected graphic function for a given number of iterations. The method also involves optionally eliminating the triggering text itself, as well as suspending the targeted graphic. The method does not require any changes to existing host software, such as the store checkout legacy application. Instead, byte string triggers are defined in the input text comprising the POS receipt and used to trigger suppression of the graphics normally merged with the legacy receipt output, thus allowing users to configure new custom control commands in the printer without having to upgrade or replace the legacy host application.

### CROSS-REFERENCE TO RELATED APPLICATIONS

The present application claims priority to U.S. Provisional Application Ser. No. 60/448,621 of the same title, filed on Feb. 20, 2003, and hereby incorporated by reference.

### BACKGROUND OF THE INVENTION

1. Field of Invention

The present invention relates to point-of-sale (POS) printers and, more specifically, to a method and system of preventing or suppressing the printing of graphic enhancements in legacy applications based on predetermined triggering events.

2. Description of Prior Art

There are a significant number of store PC terminals and point-of-sale (POS) printers in use today. The new features of current printers have made it possible to invoke color and graphics functions to enhance the appearance of receipts. The additional functions, of course, require new commands for invoking the color and graphics functions. Unfortunately, the return on the total investment in the technology often dictates doing without such enhancements.

In finding a cost effective way to achieve enhanced POS receipts there are mandatory fixed costs and options. The mandatory cost is replacing a POS printer with a new one that features color and graphics functions. Ignoring for the moment the installation and configuration fixed costs that go along with the purchase price, the expense of an application upgrade to use the new features is usually prohibitive. Changing out the application (or getting custom modifications done) is the major factor that makes the enhancements not viable. If a solution for implementing the enhancement coexists with an unchanged “legacy” retail application, these optional costs are minimized and the solution to the problem becomes more viable. The desired practical solution should also allow offsetting of these costs by targeting the new printing effects for marketing and advertising purposes.

The one choice relative to fixed costs is which printer to purchase. Some conventional printers offer several graphics commands that can be set as configuration options (these graphics remain intact across printer power cycles indicating that they are stored in non-volatile memory). These configurable graphics features can be downloaded and saved prior to first use of such a printer. If the desired graphic effects are of a static nature (similar to pre-printed receipt paper), then only a one-time configuration of these graphics is needed at installation. With this method, however, only very infrequent changes in graphics are practical by periodically performing off-line reconfiguration and graphics downloads of different logos into non-volatile memory.

If, in addition to static graphics, POS system users want the ability to change the appearance of certain items on each receipt, new functionality is necessary. Conventional POS systems do not allow for the use of the new color and graphics capabilities of the printer in the repetitive format of POS receipts. In order to bridge the visual gap between a legacy receipt and the appearance of a new receipt, while leaving unchanged the application producing the receipt, one must provide for changeable graphics in the context of a legacy application's receipts.

In addition to the problems inherent in providing the new functions using the legacy applications, there are the related problems of inserting graphics into a receipt. A secondary problem involves the art of receipt design, and must be considered when figuring the total cost of the new enhancements. Although receipt design is not directly relevant to the present invention, sufficient flexibility-in the enhancements is required in order to realize the full potential of the particular effects. For example, it is necessary to determine the location where the desired graphical surrounding of standard receipt text will be inserted. These desired results present a need for maximum flexibility, and thus requires multiple new printer functions, rather than one or two “canned” effects.

The most difficult problem with the new enhancements involves requirement that the legacy host application remaining inviolate. If this restriction is eased and the legacy application is modified, some of the functions might not be used in particular receipt formats as the decision of which functions to implement depends on a trade-off between cost of each application modification and the costs of managing periodic printer configurations.

The easiest case for implementing the enhancements involves the use of an entirely new application that has been updated to allow text printing with the new color and graphic functions. The enhancements of the present invention are useful to new applications as well, just as many POS printer additions have been in the past. If a new application is created for the printer, the entire command set, including color and graphics commands, is available. Different POS printer modes can be set, text attributes mapped differently, new logos brought down, and logo roles changed (i.e., which logo will be a header, which a watermark, which used for side margins, and which for a trailer). Additional logos could be printed at the end of a receipt.

Security may also be enhanced, for example, by serializing the margin logo. A new application could even choose to serialize a coupon logo. With any of these POS printing features, however, the mechanized production of the body content of a receipt is still difficult to enhance graphically.

Another problem presented by conventional POS system enhancements is the reluctance of application writers to depend on new functions that are only available on select printers because of the risk of marketability for an application based on one printer or printer manufacturer line.

If an application chooses to use a “least common denominator strategy” for printer functions, then any new features can be invoked only if they are available as configuration settings. New applications would need to structure their receipts to best take advantage of the configurable features, yet not be dependent on them. Therefore, automatic graphics insertion done by the printer can be useful irrespective of the age of the application. However, the automatic insertion of graphics creates another need, as there usually are a small number of receipts issued during a day that should not have some of the configured graphics printed on them. This translates into a requirement that the printer control the insertions. As the insertion of the graphic enhancements was often set up at a distant configuration time, there is a need for additional control of the configured graphics, so that any (or all) of the configured actions can be temporarily suppressed.

3. Objects and Advantages

It is a principal object and advantage of the present invention to provide a method for controlling graphic POS enhancements that reduces the costs of the system.

It is an additional object and advantage of the present invention to provide a method for controlling graphic POS enhancements that avoids the need to alter or upgrade the legacy POS application.

It is a further object and advantage of the present invention to provide a method for controlling graphic POS enhancements that allows the printer to control the timing of the insertion of the graphic enhancements into legacy POS receipts.

Other objects and advantages of the present invention will in part be obvious, and in part appear hereinafter.

### SUMMARY OF THE INVENTION

The present invention comprises a method for controlling the printing of graphic enhancements by a POS printer, such as top logos, margin messages, watermarks, surround graphics, or bottom logos, where the legacy POS application does not recognize the additional features. Predetermined text stream trigger commands are embedded into host data and sent to the printer. The printer receives the data and determines whether a trigger command has been sent. If a command has been sent, the nature of the command is determined by matching against a trigger table stored in memory. Once the particular command is identified, the appropriate action for the particular trigger is taken, including the suppression of printing of a particular graphic.

### BRIEF DESCRIPTION OF THE DRAWINGS

FIG. 1 is an illustration of a POS receipt having graphic enhancements to be controlled according to the present invention.

FIG. 2 is a flowchart of the method of controlling the printing of graphics according to the present invention.

FIG. 3 is a flowchart of the run-time processing of the legacy text triggers according to the present invention.

FIG. 4 is a flowchart of the processing of different text triggers according to the present invention.

FIG. 5 is a flowchart of the processing of a suspend trigger command according to the present invention.

FIG. 6 is a flowchart of the processing of a trigger definition command according to the present invention.

FIG. 7 is a flowchart of the method of suppressing graphics in newer printer firmware environments according to the present invention according to the present invention.

### DETAILED DESCRIPTION

The present invention comprises four novel print functions. The first step is configuring a string match in the printer input stream that triggers suppression of pre-configured legacy graphics, such as a top logo, bottom logo, surround graphic, watermark, and/or margin message. The second step is configuring a string match in the input stream that triggers enabling of configured legacy graphics. The third step is the run-time issuing of enable or disable actions for configured legacy graphics. The fourth step is providing run-time status command enhancements that report on the current configuration state for legacy graphics.

While these functions are described as being implemented in POS printer firmware, equivalent action can be coded into a host printer driver. The host driver would then transform the printer input stream that the application generates into one that needs only a primitive capability from the printer, i.e., the ability to print a raster dot row. Another option is for a host terminal printer driver to use a less featured printer model and only implement the disclosed functions by using the commands that are available and reverting to raster dot row printing for the effects that cannot be conjured from the commands available in a less featured printer.

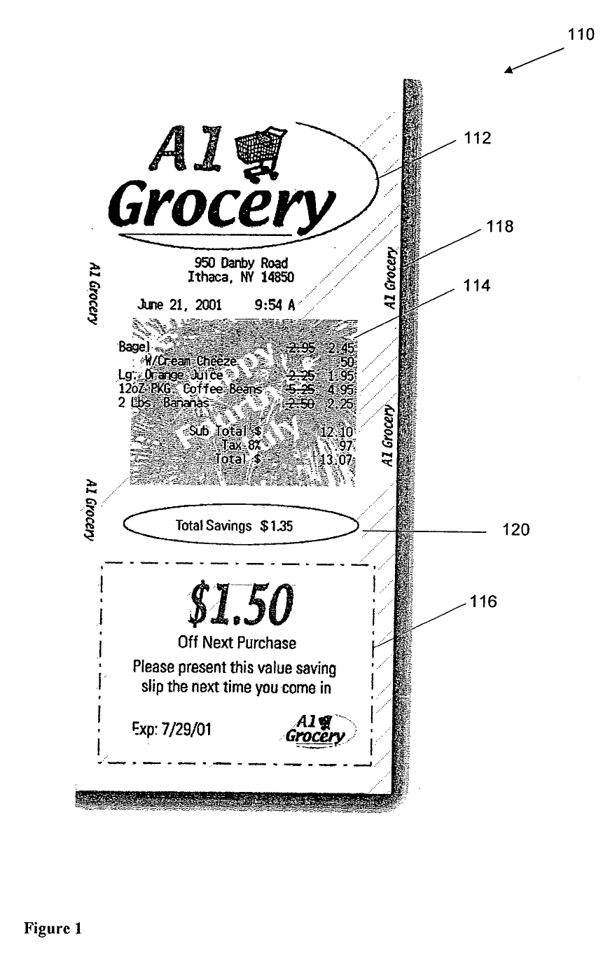

Referring now to the drawings wherein like numeral refer to like parts throughout, there is seen in FIG. 1 a sample POS receipt 110 where the name “AI Grocery” with cart design is a configured top logo 112, “Happy Fourth of July” is a configured watermark 114, “$1.50 Off . . . ” is a configured bottom logo 116 and “AI Grocery” is a configured alternating margin message 118.

In order to implement the present invention, a number of discrete functions must be defined and programmed into the printer firmware as commands for executing the method of the present invention. These functions allow for delaying for a fixed number of bytes the normal processing of input stream bytes, defining a byte string of less than or equal to max length to be stored in non-volatile storage, managing non-volatile storage for holding up to a fixed number of defined byte strings, ordering the fixed number of byte strings into fast response memory for quickest execution of a match/does not match function, checking if a subset of the delayed input byte string matches any one of a stored list of strings, acting on a match occurrence by executing the function that the match calls out, acting on a match occurrence by optionally eliminating the match string in the delayed input stream, recognizing a command to set up a string matching that then will then suppress selected graphics printing, and recognizing a command that then reports back the status of any negative match setup(s).

In the following description, the word “trigger” is used to denote the occurrence of a byte string in the input stream that will cause certain actions on the input stream and to the printout. These caused actions are termed “triggered.” Because printer commands and print data are mixed in the input stream fed to the printer, a trigger is really a user-configured definition of a new command that will be invoked by the trigger byte string. The word “legacy” is used to denote a printer input stream generator (host application) that is not aware of any of a printer's newly defined commands.

Legacy triggers provide the ability to enhance print data and to print logos without need to change existing applications. Triggers are configuration-time defined and operate by looking for matching text patterns in the print data of a receipt and either to enhance the data itself or to insert a logo.

Because legacy configuration-time settings are always-on features (since the run-time application does not know about then and thus will not turn them off), expanding the use of such printers to also include features should only be on most of the time (i.e., have exceptions) requires some way to temporarily override the always-on settings. For this purpose a new triggering method is introduced.

Following is a set of example suppression and status commands for implementing the present invention. Table 1 below illustrates a sample bit mask bit definition table for defining the bits of the parameters used in the suppression and status commands.

TABLE 1
Bit Mask Bit Definition Table

| | |
|---|---|
| Bit 0 | Bottom Logo |
| Bit 1 | Top Logo |
| Bit 2 | Ribbon Logo |
| Bit 3 | Watermark |
| Bit 4 | Triggers (Valid for Disable/Enable Legacy |
| | Feature Configuration command only) |
| Bit 5 | Attribute Substitution |
| Bit 6 | Input Substitution |

Command: Suspend Legacy Feature Trigger.

This command creates a trigger to disable a legacy feature for a specified number of knife cuts on matching the specified text in a data stream. The features to suspend are specified by setting the appropriate bit in the FeatureMask. A user may specify whether the feature should be suspended immediately, or be delayed until after the next knife cut, by setting the appropriate bit in the DelayMask. A trigger must be specified via the 1F 03 16 11 command and stored by the 1F 03 16 13 command.

Suspend Legacy Feature Trigger is implemented by the command 1F 03 16 10 [DelayMask, FeatureMask, 30, RemoveAndCount]. FeatureMask specifies the features to suspend. Setting the appropriate bit to 1 will cause this feature to be suspended. See Table 1. The trigger feature is not applicable to this command. DelayMask sets delayed suspension. Setting the appropriate bit for a feature to 1 will delay the suspending of that feature till after the next knife cut. 30H=Suspend function. RemoveAndCount specifies the number of knife cuts to suspend the feature for. The maximum number of cuts is 64 (limit is an implementation choice). Setting bit 7 of this byte a 1 will cause the trigger string to be removed from the bit stream and not printed.
Command: Enable Legacy Feature Trigger

This command creats a trigger to enable a legacy feature upon a match in the specified text in a data stream. The features that are enabled are specified by setting the appropriate bit in the FeatureMask, see Table 1. You can specify whether the feature should be enabled immediately or be delayed till after the next knife cut by setting the appropriate bit in the DelayMask. A trigger must be specified via the 1F 03 16 11 command. This trigger must be stored by the 1F 03 16 13 command.

Enable Legacy Feature Trigger is implemented by the command 1F 03 16 10 [DelayMask, FeatureMask, 31, Remove]. As explained above, FeatureMask parameter specifies the features to enable. Setting the appropriate bit to 1 will cause this feature to be enabled, see Table 1. The trigger feature is not applicable to this command. The DelayMask parameter will delay enabling that feature until after the next knife cut when the appropriate bit for a feature is set to 1. 31H=Enable legacy feature trigger function. The Remove parameter will cause the trigger string to be removed from the bit stream and thus not printed if bit 7 of this byte is set to 1.
Command: Disable Legacy Feature Trigger

This command creates a trigger to disable a legacy feature upon matching the specified text in a data stream. The features to disable are specified by setting the appropriate bit in the FeatureMask, see Table 1. By setting the appropriate bit in the DelayMask, a feature can be disabled immediately or delayed until after the next knife cut. A trigger must be specified via the 1F 03 16 11 command and stored by the 1F 03 16 13 command.

Disable Legacy Feature Trigger is implemented by the command 1F 03 16 10 [DelayMask, FeatureMask, 32, Remove]. The DelayMask, FeatureMask, 32, and Remove variables operate as explained above. 32H=Disable legacy feature trigger function.
Command: Disable/Enable Legacy Feature Configuration.

This command enables or disables a legacy feature. The feature to enable or disable is specified by setting the appropriate bit in the FeatureMask and the OnOffMask controls whether the feature is disabled or enabled. As explained above, DelayMask specifies whether the feature should be disabled or enabled immediately, or delayed until after the next knife cut.

Disable/Enable Legacy Feature Configuration is implemented by the command 1F 03 16 06 [DelayMask, FeatureMask, OnOffMask]. DelayMask and FeatureMask operate as explained above. Setting the appropriate bit in OnOffMask to 1 will enable the feature and setting to 0 will disable the feature

Following is a set of preferred status commands for implementing the present invention.
Command: Print Trigger Data.

This command prints the definition of the active triggered commands. Both standard triggers and negative triggers are printed. Print Trigger Data is implemented by the command 1F 03 16 80.
Command: Print Legacy Settings.

This command prints the on/off status of all legacy configured functions. Print Legacy Settings is implemented by the command 1F 03 16 81
Command: Print Logo Information.

This command prints details concerning all active logos and is implemented by the command 1D 9C 00 00. The print count of surround shapes stored as logos is not maintained so those print counts should be ignored.

Some of the above functions are complex because they must rely on the print text generated by a client application that is completely unaware of the graphic effects that will be added by the printer. In some cases, control over the print text contents may be too vague or the region for placement of a desired effect does not have any unique and repetitive byte strings. Fortunately, the ability to replace matched text allows configuring very precise actions. When a system implementation has the opportunity to “tweak” the input data to the printer host application by inserting unique gibberish (and/or unprintable) characters at the printout place where each effect is desired, then the new functions would be set-up with the parameter option to have the graphic replace the gibberish characters. Such applications are often described as providing “hooks” for their users to insert custom text into a standard receipt format. It is therefore important that more than just the ASCII text range (20-7F hex) be available for declaration as match strings.

The maximum length of a match string, as given in the above parameter limits, is an arbitrary value, determined by the length of likely trigger words and the prevalent printing media in use. In a POS receipt, where a maximum line is 40-60 characters (the upper number arising from printers that offer compressed fonts), a value of 24 generously exceeds all likely usage. This number can be increased, or even eliminated with commensurate increases in memory usage and implementation complexity. Both the length of the trigger strings, and the total number active at any time affect the performance of the printer.

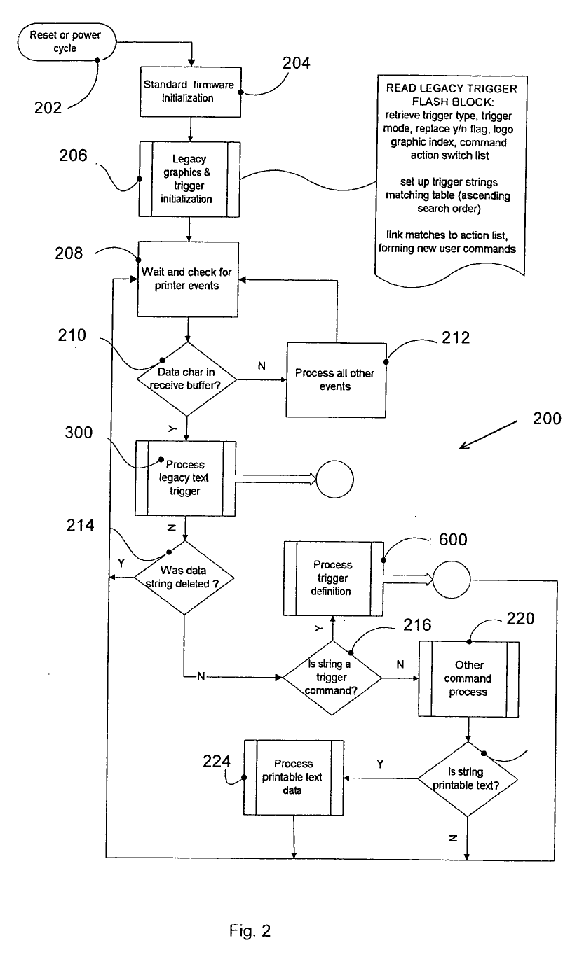

Referring to FIG. 2, the main process 200 of the present invention begins with a reset or powering 202 of a POS printer and standard firmware initialization 204. The next step is the initialization 206 of legacy graphic and triggers by retrieving from Flash memory (data that survives power cycles) the parameters of all triggers and storing in a table of ordered strings in the fastest available memory for searching for matches in the input data when it is received.

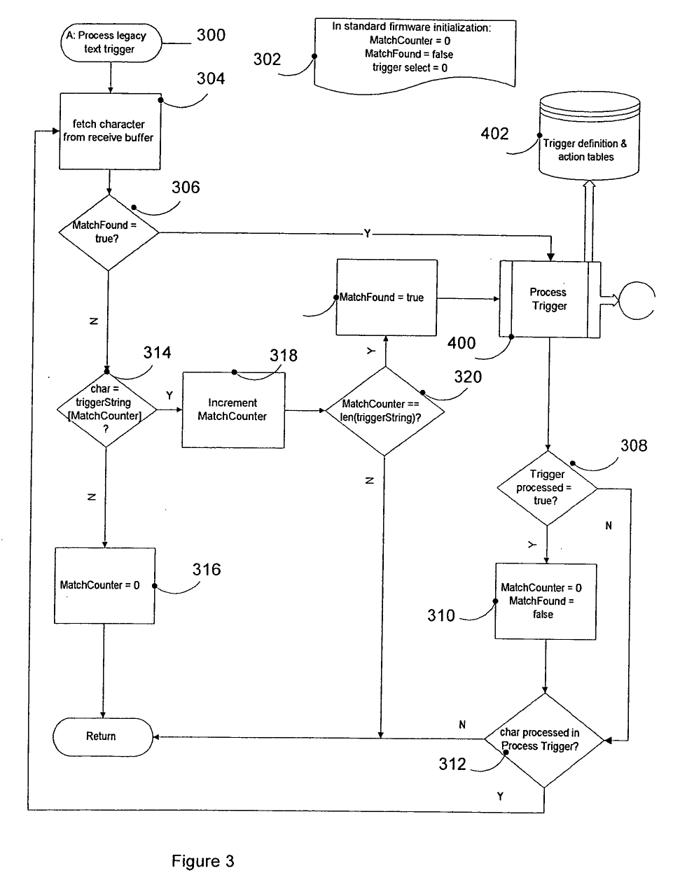

Once initialization 206 is complete, the POS printer waits for events 208. When an event occurs, the printer input buffer is assessed 210 to determine whether it contains new data. If an event is not incoming new data, standard processing 212 occurs. When incoming data is detected 210, control is passed to Process Legacy Text Trigger 300 (detailed in FIG. 3).

Once Process Legacy Text Trigger 300 is completed, as will be described hereinafter, a check is made to determine whether a trigger was deleted 214. If the trigger was not deleted, the data is tested 216 to determine whether it contains a command. If so, control passes 218 to Process Trigger Definition 600. If no string command is present in the data, the data is checked for other process commands 220. If there are no remaining commands, the data is checked printable text 222. If no printable text is present, control return to wait for event 208. If printable text is present, the printable text is processed 224 for text printing.

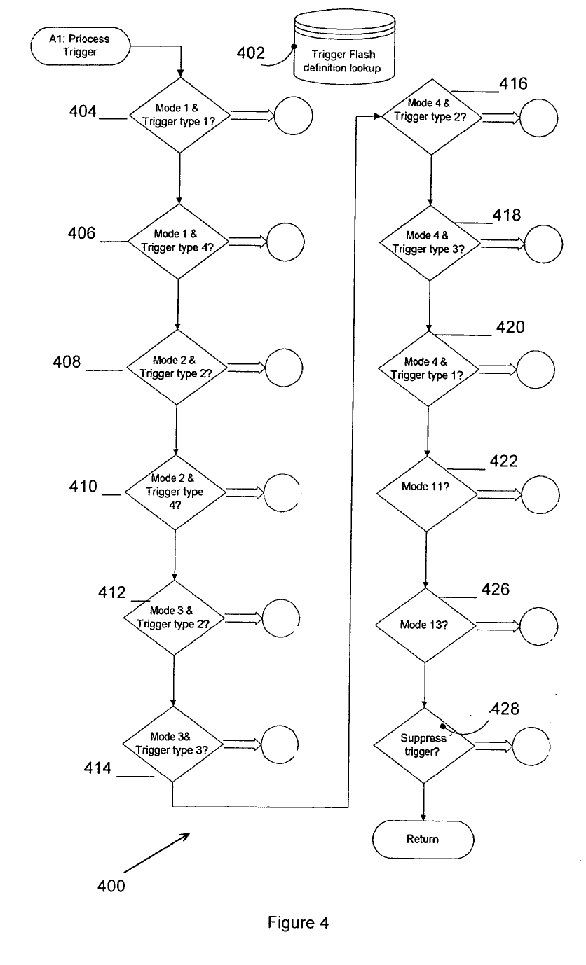

Referring to FIG. 3, Process Legacy Trigger 300 involves the run-time processing of text triggers. During power on/reset initialization of POS printer, the match variables are set to initial values 302. The character that caused an incoming data event is fetched 304 from the receive buffer and compared to stored triggers. The variable MatchFound flag is then tested 306 and, if true, processing moves to Process Trigger 400 (detailed in FIG. 4).

Following a return of control from Process Trigger 400, explained in detail herein after, a check is made to determine whether the trigger was processed 308. If so, counters are reset and a check 310 is made to determine whether characters were processed in Process Trigger 400. If yes, control returns to fetch character 304. If not, control returns to main process 200. This process allows a first trigger string be followed by an auxiliary trigger string, as stated in the commands, before all the processing is through. A trigger definition table (built from a table of trigger definition and action parameters) 402 is used to guide the processing. If a mismatch is determined when MatchFound flag is tested 306 and the character equals trigger string match 314 fails, the MatchCounter is set to zero 316 and processing returns to see if another match is possible. If the character equals trigger string match 314 is positive, the length MatchCounter is incremented 316 and a test is performed to determine whether a complete string match 320 has occurred. If so, control passes to Process Trigger 400. The outcome from Process Trigger 400 may be a request for an auxiliary string match, handled in step 310, and control is returned to beginning of main process 200.

Referring to FIG. 4, Process Trigger 400 includes a standard breakout for the different text trigger processing possible. First, the type of trigger is determined by the Trigger Flash definition lookup table 402. The process of the present invention then uses the fastest selection technique for making decisions 404-426 as to which trigger is matched, rather than the sequential iterative test shown here for visual simplicity. Such accelerating techniques have been disclosed in public software literature and are known in the art. If a Suppress Trigger is found 428, control passes to Suppress Trigger process 500.

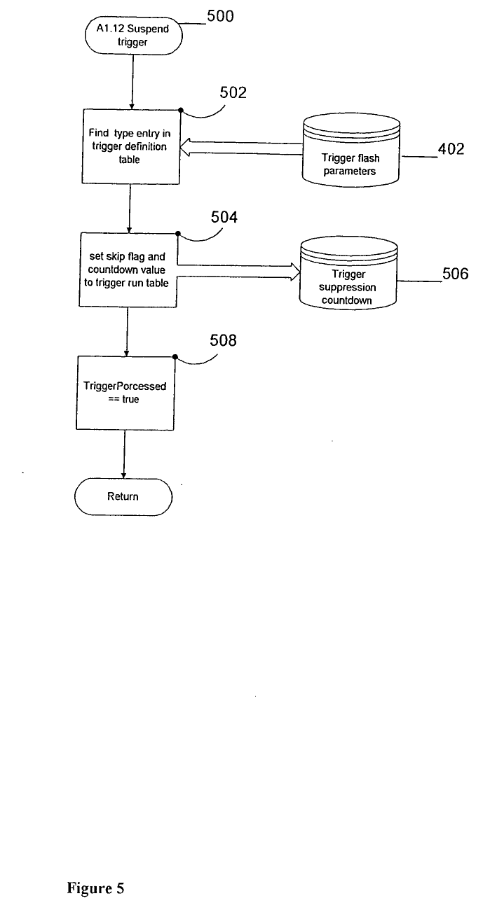

Referring to FIG. 5, Suspend Trigger process 500 begins by finding 502 the type entry in trigger definition table 402. The skip flags are then set 504 and a countdown value applied to the trigger run table by initializing the trigger suppression countdown table 506, which the affected commands reference whenever they are invoked to supply a graphic. Not shown is the decrementing to 0, at which time all configured graphic effects are set to execute normally.

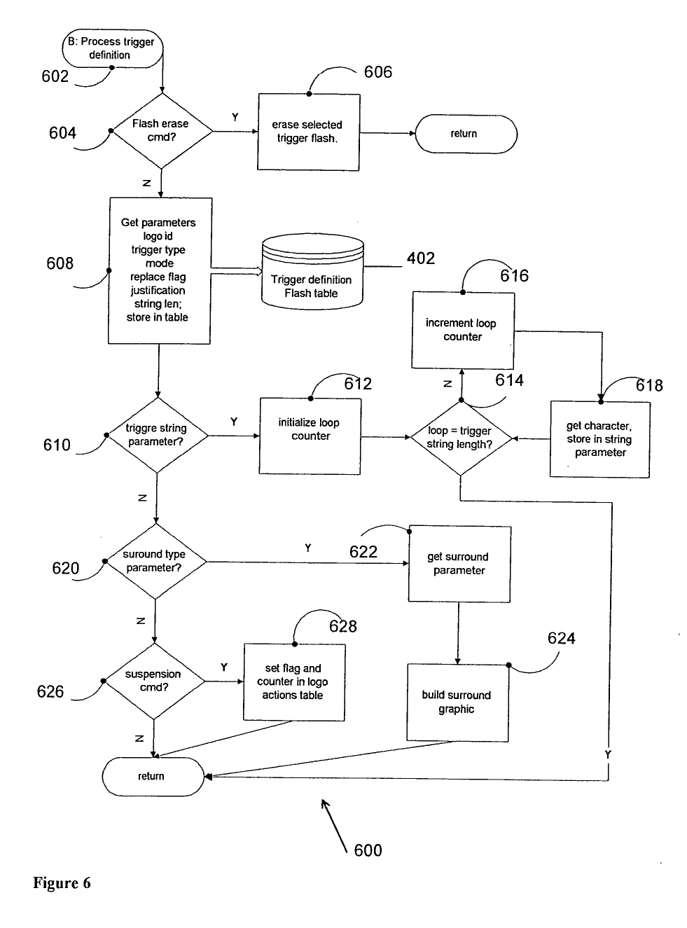

Referring to FIG. 6, Trigger Definition process 600 begins with receipt of a trigger definition command 602. If the trigger command is determined to be an erase command 604, then erasure 606 of the appropriate block or triggers is performed. Otherwise, the parameters required for each command are read and set 608 into a trigger definition table 402 stored in Flash memory. If the definition requires a trigger string parameter 610, then the string is read in steps 612-618. If the trigger definition is determined 620 to be a surround type trigger, then the parameters are loaded 622 and used to build a surround shape 624 that is ready to be used when the trigger string detected. If the trigger definition is determined 626 to be a suspension command, then its parameters are used to set values 628 in the trigger definition and action table 402.

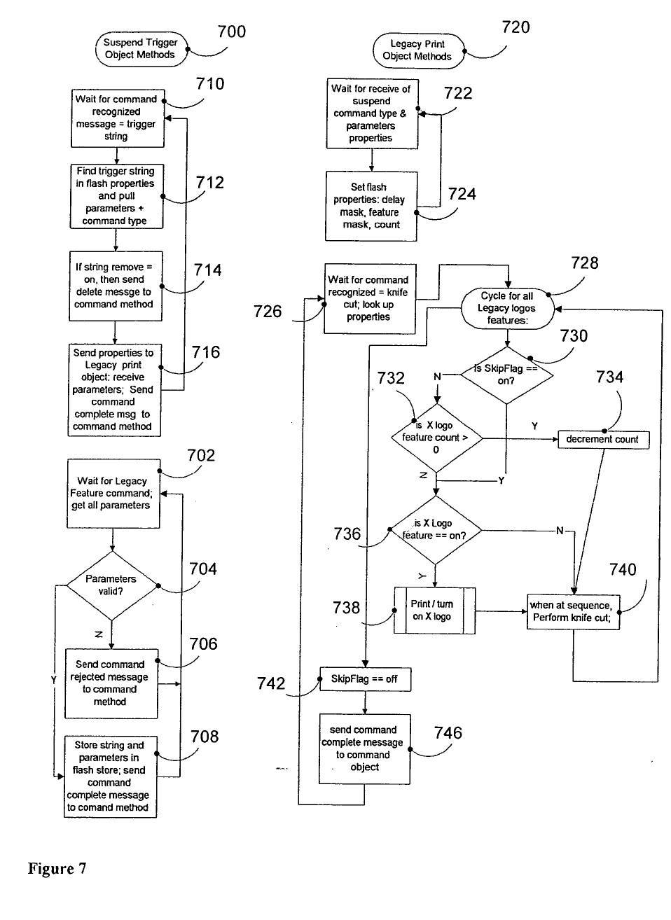

Referring to FIG. 7, the present invention is detailed in a form for use by newer printer firmware environments that may be based on operating system kernels/environments that support object programming methodology. Here the objects that implement the suspend trigger functionality are shown. It is assumed that the input stream is processed by a “command method” which waits for a few bytes that determine a command, and then waits for the rest (if any) of the command parameters. This string is then sent to the various methods that handle each of the different commands. For example, FIG. 6 details the handling of the suspend trigger commands, and the subsequent processing that these effect.

There are two methods available from Suspend Trigger Object process 700. Process 700 may begin with a wait 702 for a setup command. When the command string data arrives, the included parameters are checked for validity 704 and a reject message is sent back 706 if they are not. Valid parameters are then used to set properties, which are saved 708 in permanent (flash) memory for later use. A few of these commands may carry text strings that are to be treated like command triggers. These are saved as properties in flash memory for the command method (not shown).

The second method waits until a previously defined trigger is detected 710. There are no parameters to check, and the method extracts 712 the properties, which were saved when defined (in step 710). If the string is to be deleted, that fact is communicated 714 to the command method and all the properties needed by Legacy Print are sent 716.

The Legacy Print Object 720 has two stages. The first stage is receiving the command 722 and setting the internal working properties, i.e., Delay Mask, Feature Mask, and Count 724, which can then be used by the second stage. This implements the legacy actions that have been configured to happen when a knife cut command is received; this method waits for that event. Upon an event, properties are looked-up 726 and a sequence is started that loops 728 through bottom logo, knife cut, top logo, margin message, and watermark, in order (only sequence summary in flow chart). One of the parameters in legacy logo suspension is a one knife cut delay; this is handled by a SkipFlag property 730. If one time suspension skipping is on 730, then count down test 732 is skipped and the graphic effect is printed if it is determined to be on 736. If suspension is not on 736, then the count down value is checked 732 and, if still in count down mode, the graphic effect is skipped and the count is decremented 734. If no longer suspension counting, a check is made if the graphic effect was configured 736 (each of bottom logo, knife cut, top logo, margin message in sequence) and if set to on, the graphic effect called for is performed 738.

1. A method of suspending the printing of a special effect on the output media of a computer output device adapted to receive an input byte stream, said method comprising the steps of:
(a) identifying a triggering byte string to act as a trigger for indicating the suspension of printing of said special effect on said output media;
(b) determining whether said input byte stream includes said triggering byte string; and
(c) suspending the printing of said special effect in response to determining said triggering byte string is in said input byte stream.

2. The method of claim 1, wherein said computer output device comprises a point-of-sale printer.

3. The method of claim 2, wherein said output media comprises a receipt.

4. The method of claim 1, wherein said triggering byte string is a legacy text string.

5. The method of claim 1, wherein said special effect is a top logo, a watermark, a ribbon logo, or a bottom logo.

6. The method of claim 1, further comprising the steps of:
(d) saving said triggering byte string in memory;
(e) associating said triggering byte string with a printing function;
(f) delaying for a fixed number of bytes the normal processing of said input byte stream;
(g) executing said printing function associated with said triggering byte string after determining said triggering byte string is in said input byte stream; and
(h) optionally removing said triggering byte string from said input byte stream; and
(i) restoring normal processing of said input byte stream.

7. A method of suspending the printing of a special effect on the output media of a computer output device adapted to receive an input byte stream, said method comprising the steps of:
(a) identifying a triggering byte string to act as a trigger for indicating the suspension of printing of said special effect on said output media;
(b) determining whether said input byte stream includes said triggering byte string; and
(c) suspending the printing of said special effect for a predetermined number of printer operations in response to determining said triggering byte string is in said input byte stream.

8. The method of claim 7, wherein the step of identifying a triggering byte string to act as a trigger comprises the steps of:
(i) defining a triggering byte string of less than or equal to maximum allowable length;
(ii) storing said triggering byte string in non-volatile storage;
(ii) managing said non-volatile storage to hold a fixed number of byte strings; and
(iii) ordering said fixed number of byte strings into fast response memory for execution of a match/does not match comparison to said input byte stream.

9. The method of claim 8, wherein said computer output device comprises a point-of-sale printer.

10. The method of claim 9, wherein said output media comprises a receipt.

11. The method of claim 10, wherein said byte string is a legacy text string.

12. The method of claim 11, wherein said special effect is a top logo, a watermark, a ribbon logo, or a bottom logo.
